(19) United States
(12) Patent Application Publication
(10) Pub. No.: US 2008/0158593 A1
(43) Pub. Date: Jul. 3, 2008

(54) IMAGE FORMING APPARATUS AND PRINTING METHOD THEREOF

(75) Inventors: Yun-hye JO, Suwon-si (KR); Ui-choon Lee, Suwon-si (KR); Jung-woo Son, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/964,948

(22) Filed: Dec. 27, 2007

(30) Foreign Application Priority Data
Dec. 29, 2006 (KR) 2006-138063

(51) Int. Cl. G06F 3/12

(52) U.S. Cl. 358/1.15

(57) ABSTRACT

An image forming apparatus includes a main controller to output a printing command for each page of printing data if the printing data are received; a printing unit to print the printing data according to the printing command; and a printing controller to maintain the printing unit in a standby state until a printing command of a following page is received, if the printing of the currently printed page is completed in the case in which there exists a following page of the page currently being printed in the printing unit. Accordingly, when the printing command of the following page is received, the time for driving the printing unit again can be shortened.

### CROSS-REFERENCE TO RELATED APPLICATIONS

This application claims benefit under 35 U.S.C. §119 from Korean Patent Application No. 2006-138063, filed on Dec. 29, 2006, the entire contents of which are incorporated herein by reference in its entirety.

### BACKGROUND OF THE INVENTION

1. Field of the Invention

The present general inventive concept relates to an image forming apparatus and a printing method thereof. And more particularly, the present general inventive concept relates to a printing control apparatus to control a drive of printing and a cleaning operation according to whether there exists a following page during a continuous printing, and a printing method thereof.

2. Description of the Related Art

An image forming apparatus prints data which can be either produced by itself or prints data which is received from an outside source on a printing paper. Conventionally, the image forming apparatus includes a copying machine, a printer, a facsimile, and a multifunction peripheral (MFP) which complexly realizes the functions thereof through one unit.

In order to output printing data received from an outside source on a printing paper, the image forming apparatus performs data processes such as conversion of the received printing data from a digital type to an analog type. The image forming apparatus performs the data processing process in units of one page at a time. Further, after the data processing process is completed, the image forming apparatus generates a printing instruction in the unit of a page.

In the case in which the received printing data comprises several pages, the amount of printing data of each page may be different. The larger that the amount of printing data becomes, the longer the data processing time becomes.

After data-processing the printing data in the unit of a page, the image forming apparatus prints the processed printing data on a printing paper. The image forming apparatus processes the printing data of the next page during printing of the previous page.

After the printing data of one page, which has been processed, is printed on a printing paper, if the data processing process of the next page is not completed in the state in which the printing operation is completed, the image forming apparatus does not generate a next printing instruction even when there is printing data to be printed.

If the printing instruction is not generated, the image forming apparatus completes the printing operation forming an image on the printing paper and performs a cleaning operation while discharging the printing paper.

The conventional image forming apparatus performs the cleaning operation for a preset period of time and stops a drive motor for driving of the printing operation if the cleaning operation is completed. Thereafter, if a printing instruction on the following data is received, the image forming apparatus drives the drive motor again to perform the printing operation. Accordingly, the time for driving the drive motor again makes the printing time of the conventional image forming apparatus long.

Further, the frequent drives of the drive motor deteriorates the efficiency of the image forming apparatus.

### SUMMARY OF THE INVENTION

The present general inventive concept provides a printing apparatus and a printing method capable of shortening the printing time by controlling a drive for printing and a cleaning operation according to whether there exists a following page during a continuous printing.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including: a main controller to output a printing command for each page of printing data if the printing data are received; a printing unit to print the printing data according to the printing command; and a printing controller to maintain the printing unit in a standby state until a printing command on a following page is received, if the printing of the currently printed page is completed in the case in which there exists the following page of the page currently printed in the printing unit.

The main controller may sequentially produce printing commands on the pages of the printing data, may record existence of a following page in a flag predefined in each of the printing commands, and may provide the existence of the following page to the printing controller.

The printing controller may determine the existence of the following page for each page by checking the predefined flag.

The printing controller may control the printing unit to perform a cleaning operation if the page currently printed in the printing unit is a final one.

The printing unit may include a plurality of components to perform printing operations, and the printing controller may maintain the printing unit in the standby state by regulating drive states of the components to a preset state.

The printing unit may include a plurality of components to perform printing operations and a plurality of drive motors corresponding to the plurality of components, and the printing controller may stop one of the drive motors which corresponds to a developing unit and may maintain the other drive motors in the standby state until the printing command on the following page is received, if the printing of the currently printed page is completed in the case in which there exists the following page of the page currently printed in the printing unit.

The forgoing and/or other aspects and utilities of the present general inventive concept may also be achieved by providing a printing method of an image forming apparatus including a plurality of components, the printing method including: receiving a printing command on one page of printing data; starting a printing operation of the page according to the printing command and determining whether there exists a following page; and maintaining the plurality of components in a standby state until a printing command on the following page is received, if the printing operation of the currently printed page is completed in the state in which it is determined that there exists the following page of the currently printed page.

Whether there exists the following page may be determined by a check value obtained by checking a flag predefined in the printing command in the determining whether there exists the following page.

The printing method may further include: performing a cleaning operation and canceling the standby state, if the page is determined to be a final one.

Drive states of the components may be regulated to a preset state in the maintaining the plurality of components in the standby state.

In the maintaining the plurality of components in the standby state, one of drive motors which corresponds to a developing unit may be stopped and the other motors may be maintained in the standby state, in the case in which the drive motors to drive the plurality of components are provided separately.

The forgoing and/or other aspects and utilities of the present general inventive concept may also be achieved by providing an image forming apparatus including a printing unit to print printing data according to a printing command; and a controller system to output a printing command for each page of printing data if the printing data are received and to maintain the printing unit in a standby state until a printing command of a following page is received, if the printing of the currently printed page is completed when there exists a following page of the page currently printed in the printing unit.

The controller system can sequentially produce printing commands of the pages of the printing data, records existence of a following page in a flag predefined in each of the printing commands, and determines the existence of the following page.

The forgoing and/or other aspects and utilities of the present general inventive concept may also be achieved by providing a printing method of an image forming apparatus including a plurality of components, the printing method including starting a printing operation of a page according to a received printing command and determining whether there exists a following page to be printed; and maintaining the plurality of components in a standby state until a printing command on the following page is received, if the printing operation of the currently printed page is completed when it is determined that there exists the following page of the currently printed page to be printed.

In the determining whether there exists the following page, whether there exists the following page can be determined by a check value obtained by checking a flag predefined in the printing command.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an image forming apparatus according to an embodiment of the present general inventive concept;

FIG. 2 is a block diagram illustrating the image forming apparatus of FIG. 1 in detail;

FIG. 3 is a flow chart illustrating a printing method according to another embodiment of the present general inventive concept; and

FIG. 4 is a flow chart illustrating the printing method of FIG. 3 in detail.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

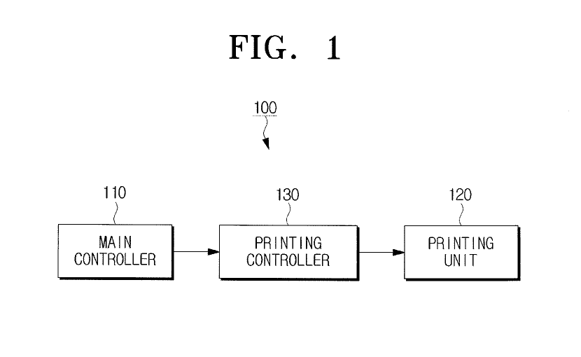

FIG. 1 is a block diagram illustrating an image forming apparatus according to an embodiment of the present general inventive concept. Referring to FIG. 1, the image forming apparatus 100 may include a main controller 110, a printing unit 120, and a printing controller 130.

In the case of a printing operation, the main controller 110 converts printing data received from a host unit to bitmap data recognized in the printing unit 120 and transmits the converted bitmap data to the printing controller 130. On the other hand, in the case of a copying operation, bitmap data scanned through a scanning unit (not illustrated) are transmitted to the printing controller 130.

The main controller 110 outputs a printing command for each page of the received printing data. Here, the printing command is a control instruction to perform a printing operation and includes flag information produced according to an existence of a following page of each page.

The printing controller 130 receives the printing command and controls the printing operation of the printing unit 120. That is, the printing unit 120 prints the printing data according to the printing command. Here, the printing unit 120 performs processes of charge, exposure, development, transfer, fixing, etc.

The printing controller 130 determines whether a following page of the page currently printed in the printing unit 120 exists and maintains the printing unit 120 in a standby state until the printing command regarding the following page is received, if the printing of the current page is completed in the case in which there exists the following page. That is, a cleaning operation performed after the completion of the printing is bypassed, thereby shortening the printing time in the case of a continuous printing.

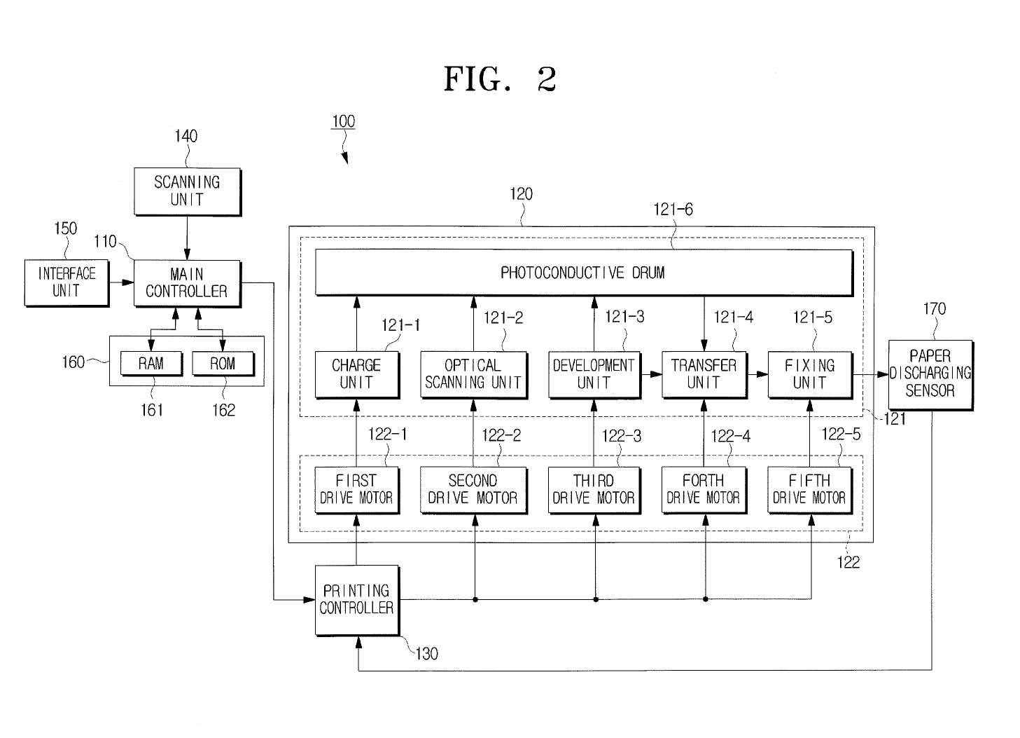

FIG. 2 is a block diagram illustrating the image forming apparatus of FIG. 1 in detail. Referring to FIG. 2, the image forming apparatus 100 further includes a scanning unit 140, an interface unit 150, a memory unit 160, and a paper discharging sensor 170. The printing unit 120 includes a charge unit 121-1, an optical scanning unit 121-1, a development unit 121-3, a transfer unit 121-4, a fixing unit 121-5, a photoconductive drum 121-6, and drive motors 122-1 to 122-5 corresponding to the components 121-1 to 121-5.

The scanning unit 140 sequentially scans a plurality of pages which are to be copied. The scanning unit 140 scans a manuscript and generates scanning data. If a user positions a plurality of manuscripts on a manuscript holding stand provided on an outer portion of the image forming apparatus, the scanning unit 140 sequentially scans the manuscript pages according to the order in which the manuscripts are positioned. The scanning unit 140 then transmits the scanned data to the main controller 110.

The interface unit 150 can be connected to a host unit (not illustrated) and receives the printing data transmitted from the host unit and transmits the printing data to the main controller 110.

The memory unit 160 can include a RAM 161 and a ROM 162.

The RAM 161 stores data provided from one of the scanning unit 140 and the interface unit 150. That is, the RAM stores the data scanned by the scanning unit 140 or stores the printing data received from the host unit. Further, the RAM temporarily stores various data generated when a program of the main controller 110 is performed.

The ROM 162 stores a control program to drive the main controller 110.

The main controller 110 converts the printing data stored in the RAM 161 to bitmap data and transmits the converted bitmap data to the printing controller 130. Further, the main controller 110 produces a printing command in the unit of a page of the printing data and transmits the printing command to the printing controller 130.

The produced printing command includes a printing execution instruction of a page and flag information in of existence of a following page.

In the case in which there exists a following page, the main controller 110 transmits the flag information recorded as “1.” Further, in the case in which there does not exist a following page, the main controller 110 transmits the flag information recorded as “0.”

If the printing controller 130 receives the bitmap data and the printing command from the main controller 110, the printing controller 130 controls the printing unit 120 to print the bitmap data according to the printing command. Further, the printing controller 130 confirms the flag information included in the printing command to control the drive and cleaning operations of the printing unit 120.

Here, the printing unit 120 includes the plurality of components 121-1 to 121-6 and the drive motors 122-1 to 122-5 corresponding to the components 121-1 to 121-5, respectively. On the other hand, the drive motors can be realized by one drive motor and can be a predetermined number of drive units according to the characteristics of the components.

The photoconductive drum 121-6 forms an electrostatic latent image by a laser beam introduced from the optical scanning unit 121-2, with the photoconductive drum 121-6 being uniformly charged at a predetermined voltage by the charge unit 121-1.

The development unit 121-3 forms a toner image by attaching a color toner of four colors of C, M, Y, and K to an electrostatic latent image forming section of the photoconductive drum 121-6.

The transfer unit 121-4 may comprise an intermediate transfer belt (ITB) which is a movement medium of the toner image formed in the photoconductive drum 121-6, a first transfer roller to transfer the toner image formed in the photoconductive drum 121-6 to the ITB, and a second transfer roller to transfer the toner image of the ITB to a record paper. The transfer unit 121-4 transfers the toner image of the C, M, Y, and K colors, which is formed on the ITB, to a printing paper.

On the other hand, the printing controller 130 performs cleaning of the ITB and the OPC during the printing operation. That is, if one color is transferred to the ITB in the photoconductive drum, the printing controller 130 controls the photo conductive drum 121-6 to be cleaned and then the next color is transferred to the ITB. Here, the cleaning is an operation to remove the toner left in the photoconductive drum 121-6 and the ITB, and the toner is removed by a cleaning blade.

The fixing unit 121-5 may include a heater roller, a temperature sensor to measure the temperature of the heater roller, and a pressing roller to fix the image transferred to the record paper while making contact with the heater roller to be rotated. The image transferred to the record paper by the transfer unit 121-4 is pressed and heated by heat and pressure while passing between the heater roller and the pressing roller.

The paper discharging sensor 170 detects the printing paper moved according to a process of the printing unit 120 and transmits a detection signal to the printing controller 130. More particularly, the paper discharging sensor 170 detects a time point at which the printing paper is discharged to the outside and detection completion of the printing operation.

The printing controller 130 checks the flag information of the printing command which is transmitted from the main controller 110 and determines whether a printing command of a following page is received from the main controller 110 if the flag information is “1.”

If a printing command of a following page is not received, the printing controller 130 maintains the drive motors 122-1 to 122-5 that drive the components 121-1 to 121-5 in a standby state. On the other hand, the drive motor of the development unit 121-3 is stopped. More particularly, the printing controller 130 sets a charge voltage, an optical scanning voltage, and a transfer voltage to a value lower than the drive voltages of the components to drive the drive motors and controls the temperature sensor to maintain the temperature of the heater of the fixing unit 121-5 at a predetermined value.

If the printing controller 130 receives a printing command of a following page from the main controller 110, the printing controller 130 cancels the standby state of the printing unit 120 and controls the printing unit 120 to perform a printing operation.

On the other hand, if the flag information of the printing command, which is transmitted from the main controller 110, is checked as “0,” the printing controller 130 determines that the currently printed page is the final page to be printed.

If the printing of the final page is completed, the printing controller 130 performs a cleaning mode. Here, the cleaning mode is a cleaning operation of the transfer roller of the transfer unit 121-4 and removes the contaminated development agent on the transfer roller by applying a reverse transfer bias to the transfer roller. The cleaning mode can be performed only after the printing operation is completed.

Accordingly, the printing time can be shortened during a continuous printing by controlling the drive of the printing unit 120 and the cleaning operation of the transfer roller according the existence or non-existence of a following page.

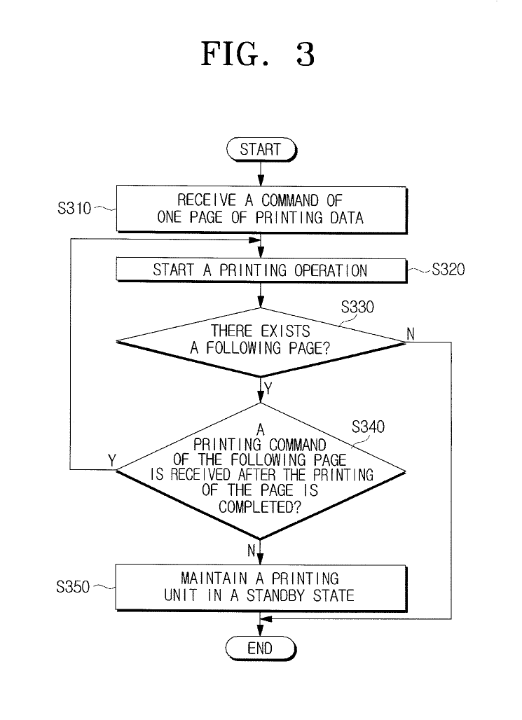

FIG. 3 is a flow chart illustrating a print method according to another embodiment of the present general inventive concept. Referring to FIG. 3, a printing command of one page of printing data is received (operation S310) and a printing operation on the page is started according to the printing command (operation S320).

Next, whether there exists a following page of the currently printed page is determined (operation S330). If it is determined that there exists a following page to be printed, whether the printing of the current page is completed is confirmed.

If the printing of the current page is completed, a plurality of components are maintained in a standby state until a printing command of the following page is received. Here, the plurality of components are those performing processes for charge, exposure, development, transfer, and fixing to perform printing. Then, the standby state is a state in which the components to perform the processes maintains drives according to preset drive voltages. On the other hand, the drive of the printing unit for development may be controlled to be stopped.

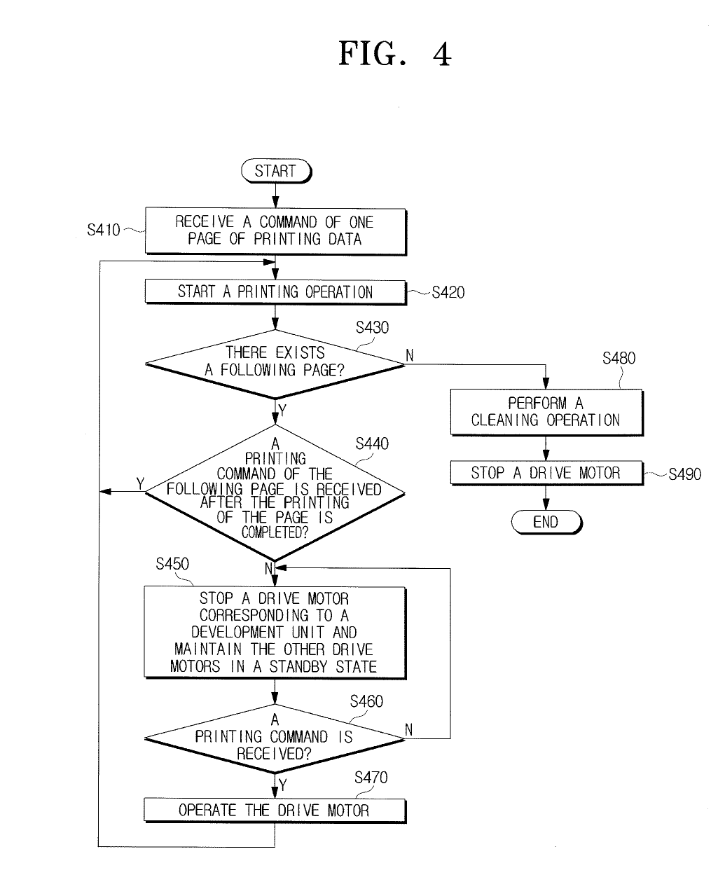

FIG. 4 is a flow chart illustrating the printing method of FIG. 3 in detail. Referring to FIG. 4, a printing command of one page of printing data is received (operation S41 0) and a printing operation on the page is started according to the printing command (operation S420).

Here, the printing command includes a printing execution instruction of a page, which is to be printed, and flag information in which existence of a following page is recorded.

Flag information predefined in the printing command is checked and whether there exists a following page of the currently printed page is determined (operation S430).

Here, if the flag information is “1,” it is determined that there exists a following page. In contrast, if the flag information is “0,” it is determined that the page currently printed is the final page.

If it is determined that there exists a following page, whether the printing of the current page is completed is determined. Then, if the printing of the current page is completed, one of drive motors of the components, which corresponds to a development unit, is stopped and the other drive motors are maintained in a standby state (operation S450). Here, the completion of the printing may be determined by a paper discharging sensor. Next, if the printing command of the following page is received (operation S460), the drive motor is driven to perform the printing of the following page. That is, operation S420 is performed again.

On the other hand, if the final page is determined to be the status, a cleaning operation is performed if the printing of the final page is completed (operation S480). Then, the cleaning operation is for a transfer roller and can be performed only after the printing operation.

Next, if the cleaning operation is completed, all of the drive motors are stopped (operation S490).

As mentioned above, according to the present general inventive concept, a drive of printing and a cleaning operation can be controlled during a continuous printing according to whether there exists a following page. Accordingly, the printing time of the continuous printing is shortened, thereby providing convenience for a user.

Further, the repetition of stopping and restarting drive motors can be avoided by maintaining the drive motors of a printing unit in a standby state, thereby extending the life spans of components.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a main controller to output a printing command for each page of printing data if the printing data are received;
a printing unit to print the printing data according to the printing command; and
a printing controller to maintain the printing unit in a standby state until a printing command of a following page is received, if the printing of the currently printed page is completed in the case in which there exists the following page of the page currently printed in the printing unit.

2. An image forming apparatus as claimed in claim 1, wherein the main controller sequentially produces printing commands of the pages of the printing data, records existence of a following page in a flag predefined in each of the printing commands, and provides the existence of the following page to the printing controller.

3. An image forming apparatus as claimed in claim 2, wherein the printing controller determines the existence of the following page for each page by checking the predefined flag.

4. An image forming apparatus as claimed in claim 1, wherein the printing controller controls the printing unit to perform a cleaning operation if the page currently printed in the printing unit is a final page.

5. An image forming apparatus as claimed in claim 1, wherein the printing unit comprises a plurality of components to perform printing operations, and the printing controller maintains the printing unit in the standby state by regulating drive states of the components to a preset state.

6. An image forming apparatus as claimed in claim 1, wherein the printing unit comprises a plurality of components to perform printing operations and a plurality of drive motors corresponding to the plurality of components, and the printing controller stops one of the drive motors which corresponds to a developing unit and maintains the other drive motors in the standby state until the printing command on the following page is received, if the printing of the currently printed page is completed in the case in which there exists the following page of the page currently printed in the printing unit.

7. A printing method of an image forming apparatus including a plurality of components, the printing method comprising:
receiving a printing command of one page of printing data;
starting a printing operation of the page according to the printing command and determining whether there exists a following page; and
maintaining the plurality of components in a standby state until a printing command of the following page is received, if the printing operation of the currently printed page is completed in the state in which it is determined that there exists the following page of the currently printed page.

8. The printing method as claimed in claim 7, wherein in the determining whether there exists the following page, whether there exists the following page is determined by a check value obtained by checking a flag predefined in the printing command.

9. The printing method as claimed in claim 7, further comprising:
performing a cleaning operation and canceling the standby state, if the page is determined to be a final page.

10. The printing method as claimed in claim 7, wherein in the maintaining the plurality of components in the standby state, drive states of the components are regulated to a preset state.

11. The printing method as claimed in claim 7, wherein in the maintaining the plurality of components in the standby state, one of drive motors which corresponds to a developing unit is stopped and the other motors are maintained in the standby state, in the case in which the drive motors for driving the plurality of components are provided separately.

12. An image forming apparatus comprising:
a printing unit to print printing data according to a printing command; and
a controller system to output a printing command for each page of printing data if the printing data are received and to maintain the printing unit in a standby state until a printing command of a following page is received, if the printing of the currently printed page is completed when there exists a following page of the page currently printed in the printing unit.

13. The image forming apparatus according to claim 12, wherein the controller system sequentially produces printing commands of the pages of the printing data, records existence of a following page in a flag predefined in each of the printing commands, and determines the existence of the following page.

14. A printing method of an image forming apparatus including a plurality of components, the printing method comprising:
starting a printing operation of a page according to a received printing command and determining whether there exists a following page to be printed; and
maintaining the plurality of components in a standby state until a printing command on the following page is received, if the printing operation of the currently printed page is completed when it is determined that there exists the following page of the currently printed page to be printed.

15. The printing method as claimed in claim 14, wherein in the determining whether there exists the following page, whether there exists the following page is determined by a check value obtained by checking a flag predefined in the printing command.
